(19) United States
(12) Patent Application Publication
(10) Pub. No.: US 2015/0132045 A1
(43) Pub. Date: May 14, 2015

(54) MOTOR-VEHICLE CAST PART

(71) Applicants: Thomas KINKELBUR, Dortmund (DE); Markus FOIDL, Finnentrop (DE); Nadine SCHOENEWALD, Attendorn (DE); Josef STRAUTZ, Attendorn (DE)

(72) Inventors: Thomas KINKELBUR, Dortmund (DE); Markus FOIDL, Finnentrop (DE); Nadine SCHOENEWALD, Attendorn (DE); Josef STRAUTZ, Attendorn (DE)

(21) Appl. No.: 14/533,757

(22) Filed: Nov. 5, 2014

(30) Foreign Application Priority Data
Nov. 11, 2013 (DE) 102013112358.9

(51) Int. Cl. B62D 27/02

(52) U.S. Cl. CPC B62D 27/02
USPC 403/267; 428/594

(57) ABSTRACT

The invention relates to a shaped part (1) composed of metal, in particular steel, for a motor vehicle, comprising a hole (2) for a fastener and a perforated reinforcement plate (3) composed of metal, in particular steel, that covers the hole (2) and is fastened to the shaped part (1), wherein the reinforcement plate (3) is mounted at a spacing (4) from the shaped part (1) and is attached to the shaped part (1) only in at least one limited portion.

The invention relates to a shaped part of metal, in particular steel, for a motor vehicle, having a throughgoing hole for a fastener and a perforated reinforcement plate of metal, in particular steel, that covers the hole and is fastened to the shaped part.

The approach is well-known in the prior art whereby shaped parts composed of metal, in particular steel, are reinforced by plates or sheet metal, in particular steel, in areas where they are attached to other shaped parts or body components.

Reinforcement is required at the joining points between the shaped part and other shaped parts or body components since the parts have holes at these joining points so as to allow them to be bolted or riveted together, with the result that these joining points form a weak point due to these holes. The weak point can be reinforced by attaching metal sheet or plates. These reinforcement metal sheet or plates are circumferentially attached at the outer edges to the shaped part, for example, soldered on or welded on.

In order to provide lasting corrosion protection, the shaped parts have a corrosion-protective coating applied to them, the metal sheet or plates for reinforcement already having been securely attached to the shaped part. Applying the corrosion-protective coating is typically effected using CDC or cathodic dip coating.

The key disadvantage observed with the described measures taken to reinforce the shaped parts is that the corrosion protection cannot get in between the shaped part and the reinforcement metal sheet or plates when the shaped parts are coated together with the reinforcement metal sheet or plates. As a result, the surfaces between the shaped part and the metal sheet or plate remain free of corrosion protection. Moisture can penetrate over time through extremely small cracks in this area, thereby resulting in corrosion on the contact surfaces of the parts.

Based on this prior art, the object of the invention is therefore to provide a shaped part including a reinforcement metal sheet with improved corrosion protection.

In order to achieve this object, the invention proposes an approach whereby the reinforcement plate is mounted at a spacing from the shaped part, and is attached only in at least one limited portion to the shaped part.

This has the advantage that a corrosion-protection agent applied to the shaped part and the reinforcement metal sheet securely attached thereto can also penetrate into the gap between the shaped part and the reinforcement plate, thereby allowing the surfaces of the shaped part that abut each other in the specified assembly position to have the corrosion protection applied to them while preventing any corrosive spots to be created. The parts in the specified assembly position are pulled together against each other by a bolt passing through the hole.

Attachment of at least one limited portion of the reinforcement plate to the shaped part enables the reinforcement plate to be fixed on the shaped part in the spaced assembly position. Another advantageous aspect is that the approach results in substantially lower cost in terms of attaching the reinforcement plate to the shaped part since the reinforcement sheet no longer has to be soldered or welded all around its outer edge, but only at the limited portion.

When final assembly is effected, another shaped part or body component, for example is bolted onto the shaped part or body component such that the individual parts are pulled together against each other by the screwing action and the reinforcement plate bears tightly against the shaped part. These measures also prevent the contact surfaces between the shaped part and the reinforcement plate from being corroded by liquid entering through extremely small gaps.

While the shaped part is being bolted onto another shaped part or body component, angular forces act on the individual components through the fastener, for example the bolt. The fact that at least one limited portion of the reinforcement plate is attached to the shaped part means that this plate cannot rotate in the same direction simultaneously with the fastener, but remains in the intended position.

Provision is preferably made whereby the reinforcement plate has at least one tab forming the limited portion, which tab is at the outer edge of the reinforcement plate, is angled toward the shaped part, and is attached to the shaped part.

The tab that is angled toward and attached to the part secures the reinforcement plate on the shaped part with a certain clearance from the shaped part, with the result that a spacing is provided between the shaped part and the reinforcement plate when in the specified assembly position, into which gap corrosion-protection agent penetrates. Other shaped parts or body components can be attached to the shaped part during final assembly by a screwing action such that the other shaped part or body component presses the reinforcement plate against the shaped part. The tab does not present any significant resistance here and easily deforms, with the result that as the tab deforms the reinforcement plate creates a flat contact surface between the shaped part and another shaped part or body component, and enables all of the components to be optimally secured to each other.

Each reinforcement plate has at least one tab in the form of a limited portion on two opposing outer edges, which tab is angled toward the shaped part.

This ensures reliable retention of the reinforcement plate on the shaped part. Angular forces act through the fastener on the individual components, in particular, during final assembly when additional shaped parts or body components are bolted onto the shaped part. The fact that the reinforcement plate is attached by tabs at two opposite outer edges means that the plate cannot rotate simultaneously in the same direction as the fastener and is retained securely on the shaped part.

Provision is furthermore preferably made whereby the reinforcement plate and the shaped part are attached in the at least one limited portion to each other by joining means, where provision is especially preferably made whereby the reinforcement plate and the shaped part are soldered, welded, or adhesively bonded together in the at least one limited portion.

The shaped part and the reinforcement plate are attached to each other by a joining method, whereby they are preferably soldered or welded in order to ensure a secure attachment that is both inexpensive and strong. However, other joining methods can be used to unite the parts.

An embodiment of a shaped part according to the invention for a motor vehicle is shown in the drawing and described below.

### Therein:

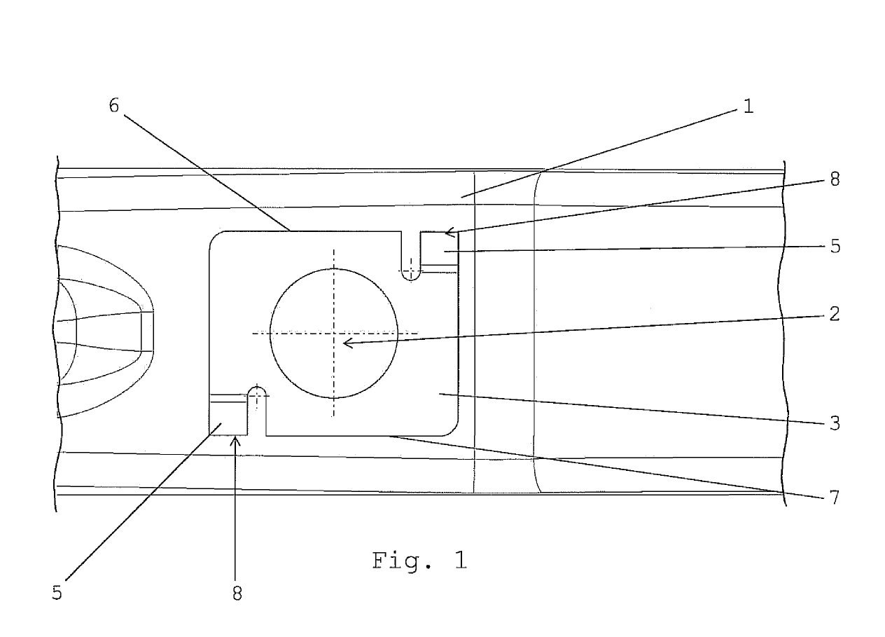

FIG. 1 is a top view of a shaped part including a reinforcement plate;

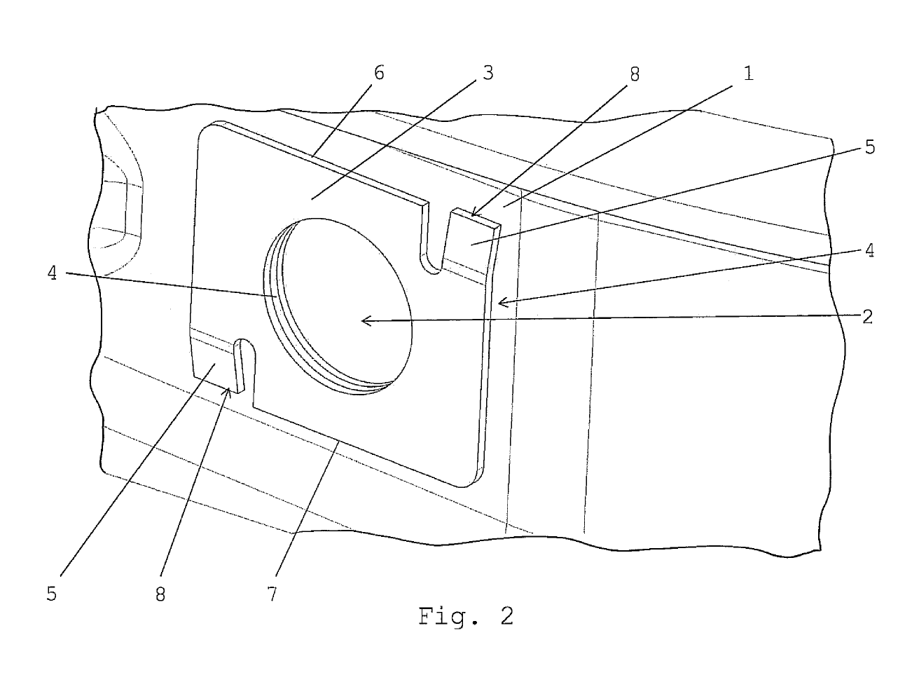

FIG. 2 is an isometric view of the shaped part including reinforcement plate;

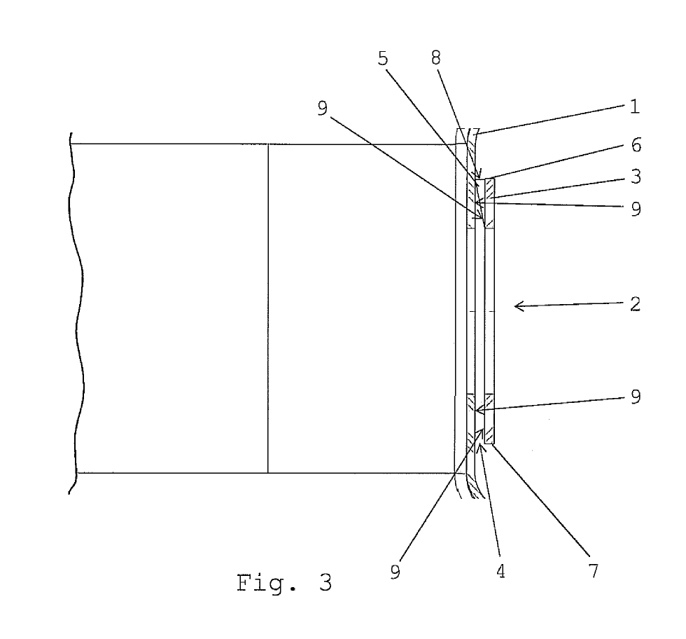

FIG. 3 is an end view of same, partly in section.

FIG. 1 shows a shaped part 1 for a motor vehicle, comprising a throughgoing hole 2 for a fastening element and a perforated reinforcement plate 3 covering the hole 2 and fixed to the shaped part 1. The reinforcement plate 3 in this embodiment is basically rectangular, although it is possible to use a reinforcement plate 3 with another shape. The shaped part 1 can be a body or a frame component. All parts are composed of metal, preferably steel.

Other shaped parts or body components can be attached to the shaped part 1 but are not shown in the drawing, the hole 2 being provided to allow insertion of a fastener appropriate for effecting secure attachment, in particular, a bolt.

The reinforcement plate 3 has two limited portions for secure attachment of the plate to the shaped part 1, these being in the form of tabs 5 which, as highlighted in FIGS. 2 and 3, are angled toward the shaped part 1 and that securely attach the reinforcement plate 3 to the shaped part 1 in a specified assembly position with a spacing 4 from the shaped part 1. The tabs 5 are on two opposing outer edges 6 and 7 of the reinforcement plate 3, ends 8 of the plate being attached by joining to the shaped part 1, for example, welded or soldered. This is advantageous since angular forces during the screwing action act through the fastener on the individual components, and any improper rotation by the reinforcement plate 3 in the rotation direction of the fastener is precluded due to the secure attachment of the reinforcement plate 3 by the diagonally opposite tabs 5.

Attachment between the shaped part 1 and the reinforcement plate 3 is effected in the region of edges 8 of the tabs 5 by welding or soldering. Other joining technologies are also possible, however.

FIG. 3, in particular, illustrates that the reinforcement plate 3 is offset by the spacing 4 from the shaped part 1. The reinforcement plate 3 is held at the spacing 4 from the shaped part 1 by the tabs 5 that are angled toward the shaped part 1. When a coating of corrosion-protection agent is applied, the corrosion-protection agent also gets into the spacing 4 between the shaped part 1 and the reinforcement plate 3, with the result that contact surfaces 9 of both parts, which are pressed against each other in the specified assembly position, are also coated with a corrosion-protection agent.

The invention is not restricted to the illustrated embodiment but can be varied in multiple ways within the scope of the invention.

All novel individual features and combined features that are disclosed in the description and/or drawing are considered to be essential to the invention.

1. In combination with a shaped part composed of metal for a motor vehicle and having a throughgoing hole for a fastener, a perforated reinforcement plate
that is composed of metal
that covers the hole and is fastened to the shaped part
that is mounted at a spacing from the shaped part and
that is attached to the shaped part only in at least one limited portion.

2. The combination defined in claim 1, wherein the reinforcement plate has at least one tab forming the limited portion, which tab is at an outer edge of the reinforcement plate and angled toward the shaped part, the tab being attached to the shaped part.

3. The combination defined in claim 1, wherein there are two of the limited portions, and the reinforcement plate has on each of two opposite outer edges at least one tab each forming a respective one of the two limited portions, the tabs each being angled toward the shaped part.

4. The combination defined in claim 1, wherein the shaped part is of an essentially rectangular or round shape.

5. The combination defined in claim 1, wherein the reinforcement plate and the shaped part are bonded to each other at the at least one limited portion.

6. The combination defined in claim 1, wherein the reinforcement plate and the shaped part are soldered, welded, or adhesively bonded together at the at least one limited portion.

7. The combination defined in claim 1, wherein the part is of steel.

8. The combination defined in claim 1, wherein the plate is of steel.

9. An assembly comprising:
a base shaped part formed with a throughgoing hole;
a reinforcement plate juxtaposed with the base shaped part and formed with
a throughgoing hole aligned with the hole of the base shaped part, and
a pair of edge tabs bent toward and engaging the base shaped part and holding the reinforcement plate between the tabs at a spacing from the base shaped part; and
means bonding the reinforcement plate to the base shaped part only at the tabs.

10. The assembly defined in claim 9, further comprising:
a fastener engaged through the aligned holes and pressing the plate and part toward each other.

11. The assembly defined in claim 9, wherein the plate is generally rectangular, the respective hole is generally central, and the tabs are diagonally opposite each other at corners of the plate.

12. The assembly defined in claim 11, wherein the bolt deforms the plate and/or the part such that the plate and the part bear against each other at the holes.

13. The assembly defined in claim 9, wherein the bonding means is a weld.

14. The assembly defined in claim 9, further comprising:
an anticorrosion covering all surfaces of the plate and part, even confronting spaced faces between the plate and part.
